(19) United States
(12) Patent Application Publication
(10) Pub. No.: US 2005/0246865 A1
(43) Pub. Date: Nov. 10, 2005

(54) Tailgate hinge having a corrosion-resistant structure

(76) Inventor: Eui Jun Kim, Gunpo-si (KR)

Correspondence Address: MORGAN, LEWIS & BOCKIUS LLP (SF), 2 PALO ALTO SQUARE, PALO ALTO, CA, 94306, US

(21) Appl. No.: 11/022,232

(22) Filed: Dec. 23, 2004

(30) Foreign Application Priority Data
May 4, 2004 (KR) 2004-31212

(51) Int. Cl. B62D 33/027

(52) U.S. Cl. 16/367

(57) ABSTRACT

The tailgate hinge includes a base, an arm having a curling portion at one end of thereof, and a hinge pin for rotatably coupling the arm to the base. A terminal of the curling portion is spaced apart from the arm by a gap which has a size that is small enough to prevent the hinge pin from escaping therethrough. Preferably, the curling portion is also provided with an opening at the surface thereof. The gap and the opening facilitate the discharge of the moisture accumulated inside curling portion, so that the corrosion of the hinge can be effectively prevented.

### CROSS REFERENCE TO RELATED APPLICATION

This application is based on, and claims priority to Korean Patent Application No. 10-2004-0031212, filed on May 4, 2004, the disclosure of which is hereby incorporated by reference.

### TECHNICAL FIELD OF THE INVENTION

The present invention relates to a tailgate hinge of a vehicle, and more particularly to a tailgate hinge having an improved corrosion-resistance structure which effectively prevents corrosion of a hinge pin and a curling part of the hinge.

### BACKGROUND OF THE INVENTION

A van or recreational vehicle is typically provided with a tailgate at the rear end thereof for loading luggage. The tailgate is pivotally connected to the body of a vehicle by means of a tailgate hinge. The tailgate hinge is an assembly comprising a base, an arm and a pin for rotatably coupling the arm to the base. Such elements are generally plated with zinc in order to increase corrosion-resistance properties before fabrication. After assembling the elements, the tailgate hinge is fixed to the predetermined position of a vehicle and then goes through a painting process consisting of an electro-disposition coating, an intermediate layer coating and top layer coating.

As an example, a conventional tailgate hinge according to a prior art is shown in FIG. 5 and FIG. 6. Referring to FIG. 5 and FIG. 6, the conventional tailgate hinge comprises a U-shaped base 10a that is fixed to the body of a vehicle and an arm 12a whose one end is provided with a curling portion 14a, through which a hinge pin 16a is inserted. The arm 12a is rotatably coupled with the base 10a by means of the hinge pin 16a in such a manner that both ends of the hinge pin 16a inserted into the curling portion 14a of the arm 12a are engaged with the U-shaped base 10a at the both ends thereof. The curling portion 14a defines a cylindrical cavity therein is constituted by rolling the one end of the arm 12a until the end substantially contacts the surface of the arm 12a.

As described above, the inner surface of the cavity defined by the curling portion and the hinge pin inserted into the cavity are hardly coated by electro-disposition coating because the curling portion has a closed structure. Therefore, the tailgate hinge according to the prior art allows moisture to accumulate between the hinge pin and the inner surface of the cavity due to a surface tension, which results in corrosion of the curling portion, especially both ends of the curling portion.

### SUMMARY OF THE INVENTION

The present invention provides a tailgate hinge having a corrosion-resistance structure, which is capable of preventing accumulation of moisture between a hinge pin and the inner surface of the cavity defined by a curling portion of an arm. In one embodiment, the tailgate hinge comprises a base, an arm having a curling portion at one end of thereof, and a hinge pin for rotatably coupling the arm to the base. A terminal of the curling portion is spaced apart from the arm by a gap, whose size is small enough to prevent the hinge pin from escaping therethrough. The curling portion may be provided with an opening at the surface thereof.

### BRIEF DESCRIPTION OF THE DRAWINGS

The aforementioned aspect and other features of the present invention will be explained in the following detailed description, taken in conjunction with the accompanying drawings, wherein:

FIG. 1a is a photograph of a tailgate hinge according to an embodiment of the present invention;

FIG. 1b is a cross-sectional view of an arm of a tailgate hinge according to an embodiment of the present invention;

FIG. 1c is a perspective view of an arm of a tailgate hinge according to an embodiment of the present invention;

FIG. 2 is a photograph showing corrosion test results rendered on tailgate hinges according to the present invention;

FIG. 3 is a photograph showing coating status of hinge pins inserted into tailgate hinges according to the present invention;

FIG. 4 is a photograph showing a partially cut away hinge pins according to the present invention, which have been subjected to a corrosion test;

FIG. 5 shows a photograph of a conventional tailgate hinge; and

FIG. 6 shows a side view of a conventional tailgate hinge.

### DETAILED DESCRIPTION OF PREFERRED EMBODIMENT

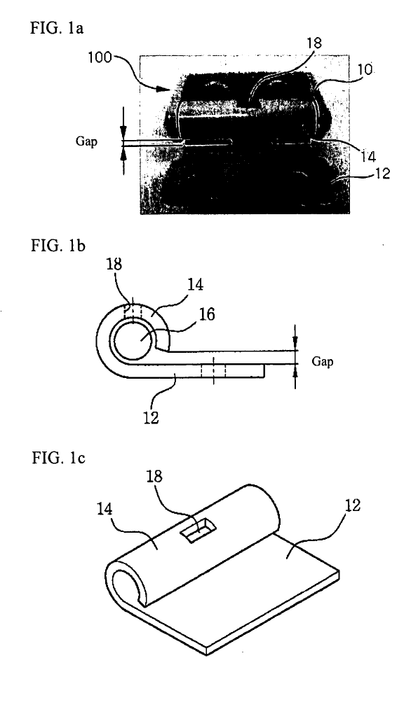

Referring to the accompanying FIGS. 1a, 1b, and 1c, a tailgate hinge 100 comprises a base 10, an arm 12, and a hinge pin 16 for rotatably coupling the base 10 and the arm 10. The base 10 has two holes therein for receiving the hinge pin 16. Formed at one end of the arm 12 is a curling portion 14 adapted to enclose the hinge pin 12 therein, The elements of the tailgate hinge 100 are plated with zinc so as to obtain corrosion-resistance properties before fabrication. After installing the tailgate hinge 100 to a body of a vehicle, the tailgate hinge 100 subsequently undergoes a painting process consisting of an electro-disposition coating, an intermediate layer coating and top layer coating.

The end of curling portion 14 is spaced apart from the surface or planar portion of the arm 12 with a gap. The size of the gap is small enough to prevent the hinge pin 16 from passing therethrough. Furthermore, the curling portion 14 is provided with an opening 18 on the surface thereof in order to facilitate a coating procedure. The curling portion 14 may be tack welded to the planar portion of the arm 12.

The effect of corrosion-resistance structure of the preferred embodiment of the tailgate hinge according to the present invention is appreciated with reference to the result of a corrosion test described below.

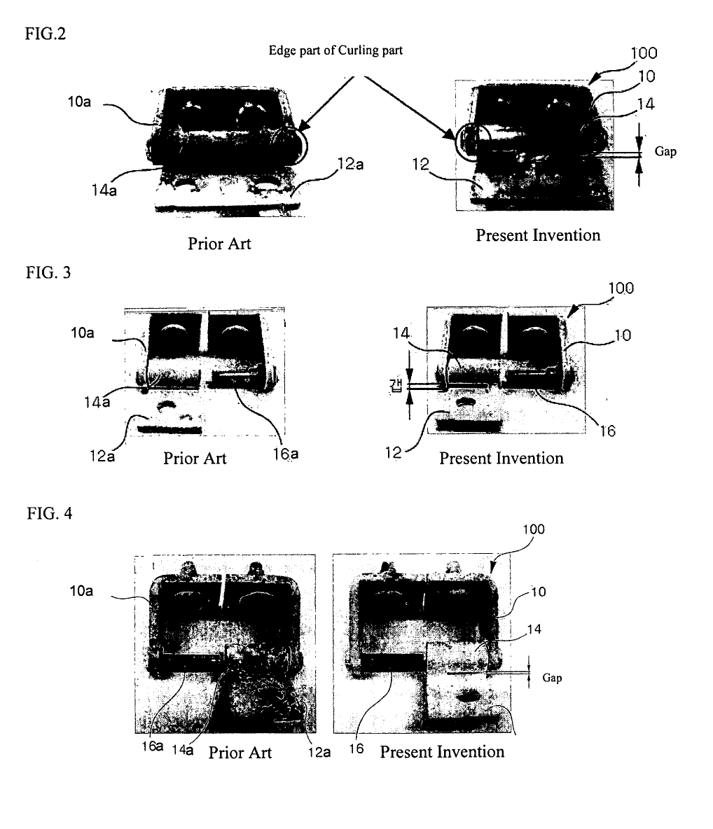

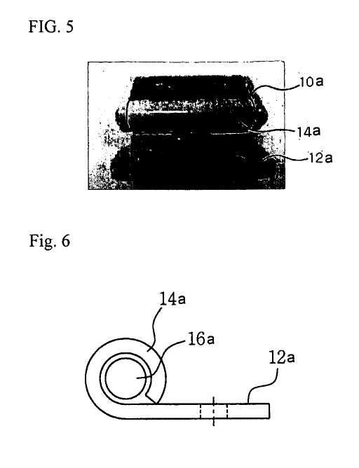

FIG. 2 is a photograph showing corrosion test results rendered on tailgate hinges according to the present invention as compared to a conventional hinge. The corrosion test was performed on tailgate hinges plated with zinc only by a salt spray test (SST). One hundred fifty two (152) hours after salted water had been sprayed to the tailgate hinges 100, it was observed that in the tailgate hinge of the invention had very little rust except at both lateral ends of the curling portion 14 of the arm. However, the conventional tailgate hinge was substantially covered by rust throughout. In the conventional tailgate, the rust initially formed at both lateral ends of the curling portion 14, and finally spread to the entire hinge. As understood from the foregoing test, it should be appreciated that the gap formed between the surface of the arm and the end of the curling significantly improves corrosion-resistance properties by preventing the accumulation of water, caused by surface tension between the outer surface of the hinge pin and the inner surface of the cavity defined by the curling portion.

FIG. 3 is a photograph showing a coating status of hinge pins inserted into tailgate hinges according to the present invention as compared to a conventional hinge. As shown in the photograph, a coating layer on the hinge pin of the present invention is properly formed by an electro-deposition coating method. However, in the conventional tailgate hinge, which is not provided with the gap, a coating layer is not sufficiently, evenly formed on the surface of the hinge pin. Moreover, in the tailgate hinge according to the present invention, a coating material easily penetrates deep into the cavity of the curling portion 14 through the opening 18. This allows the electro-deposition coating to be performed throughout the surface of the hinge pin 16.

FIG. 4 is a photograph showing corrosion test results rendered on tailgate hinges according to the present invention as compared to conventional hinges. The corrosion test (SST) was performed on tailgate hinges which had undergone an elector-deposition coating and general painting process. One thousand (1000) hours after spraying salted water to the tailgate hinges, it was observed that the corrosion in the conventional hinge has rapidly progressed as compared with that of the present invention, which is provided with the gap in the curling portion.

Accordingly, the tailgate hinge according to the present invention allows the electro-deposition of the coating layer on the inner surface of the curling portion and the outer surface of the hinge pin to be properly performed. Furthermore, the tailgate hinge according to the present invention has improved corrosion-resistance by providing the opening at the curling portion, to effectively prevent the accumulation of moisture.

Even though the present invention is described in detail with reference to the foregoing embodiment, it is not intended to limit the scope of the present invention thereto. It is evident from the foregoing that many variations and modifications may be made by a person having ordinary skill in the present field without departing from the essential concept of the present invention.

1. A tailgate hinge comprising:
a base;
an arm having a curling portion at one end of thereof;
and a hinge pin for rotatably coupling the arm to the base, wherein the end of the curling portion is spaced apart from the arm with a gap, whose size is small enough to prevent the hinge pin from escaping therethrough.

2. The tailgate hinge according to claim 1, wherein the curling portion is provided with an opening at the surface thereof.

3. A tailgate hinge comprising:
a base configured to be coupled to a vehicle;
an arm comprising a planar portion and a curled portion, wherein at least part of an end of the curled portion remote from the planar portion is spaced apart from the planar portion by a gap; and
a hinge pin configured to rotatably couple the arm to the base.

4. The tailgate hinge of claim 3, wherein the gap is small enough to prevent the hinge pin from passing therethrough.

5. The tailgate hinge of claim 3, wherein the curled portion is provided with an opening therein for allowing the hinge to be coated therethrough.

6. The tailgate hinge of claim 3, wherein the curled portion is welded to the planar portion.

7. A hinge comprising:
a base having at least one hole therein;
an arm having a flat portion and a curled portion separated therefrom by a gap; and
a hinge pin configured to t within said at least one hole and said curled portion without being capable to pass through said gap.

8. The tailgate hinge of claim 7, wherein the gap is small enough to prevent the hinge pin from passing therethrough.

9. The tailgate hinge of claim 7, wherein the curled portion is provided with an opening therein for allowing the hinge to be coated therethrough.

10. The tailgate hinge of claim 7, wherein the curled portion is welded to the planar portion.
